(19) United States
(12) Patent Application Publication
(10) Pub. No.: US 2022/0003199 A1
(43) Pub. Date: Jan. 6, 2022

(54) SYSTEMS COMPRISING MULTIPLE AND INTERCONNECTED TURBINES FOR GENERATION RENEWABLE ENERGY RELYING ON THE NATURAL PROPERTIES OF THE FLUIDS AND NATURAL FORCES, BY RUNNING PUMPS, COMPRESSORS, OR BOTH

(71) Applicant: Hayder Mohammed Jaber Alsultani, Arlöv (SE)

(72) Inventor: Hayder Mohammed Jaber Alsultani, Arlöv (SE)

(21) Appl. No.: 17/368,763

(22) Filed: Jul. 6, 2021

Related U.S. Application Data
(60) Provisional application No. 63/048,562, filed on Jul. 6, 2020.

(51) Int. Cl. F03B 13/06; H02K 7/18

(52) U.S. Cl. CPC F03B 13/06; F05B 2220/706; F05B 2220/32; H02K 7/1823

(57) ABSTRACT

A system and method for generating electrical energy including a power source, an electric pump power by power supply, a filter connected to ump and a tank, the tank connected to another filter, the other filter connected to one or more turbine rooms, the one or more turbines connected to a generator, the last turbine room connected to a vacuum chamber, the vacuum chamber connected to data logger and generators, and the data logger connected to the pump.

### CROSS REFERENCE TO RELATED APPLICATION

This application claims priority under 35 USC 119 from U.S. Provisional Application Ser. No. 63/048,562 filed on Jul. 6, 2020 and titled Systems Comprising Multiple and Interconnected Turbines for Generation Renewable Energy Relying on the Natural Properties of the Fluids and Natural Forces, by Running Pumps, Compressors, or both by Hayder Mohammed Jaber Alsultani, the entire disclosure of which is incorporated herein by reference.

### FIELD OF INVENTION

The present invention relates to energy generation and more particularly, to renewable electrical energy generation using systems including multiple and interconnected turbines for generating renewable energy relying on the natural properties of the fluids and natural forces, by running pumps, compressors, or both.

### BACKGROUND

Due to problems like environmental destruction and depletion of natural resources, systems for renewable energy generation fields are attracting more attention than before. Furthermore, the importance of new renewable energies, such as solar electricity and wind electricity, is increasing. Especially, since renewable energies are derived from natural resources, such as sunlight, wind, and tides, and do not create pollution, methods of utilizing renewable energies are being actively researched and developed. Therefore, there is a need for improved systems for generating power from renewable sources of energy that may overcome one or more of the abovementioned problems and/or limitations. The problems of global warming have brought humanity to confront the most important challenge, and with the growth of these problems, the interest in renewable energy has increased as an alternative to fossil fuel energy and nuclear energy. However, despite the great development that is happening rapidly in the current renewable energy systems, one of the most important challenges facing these systems is the instability of energy. These systems depend on non-stationary sources. For example, in solar energy, there are the problems of sunset, sunrise, and cloudy weather. With wind turbines, there are the problems of wind speed, direction, and so forth. This makes these systems incapable of solving problems beyond human control or even developing these systems in a way that can stand against these problems. Therefore, the present invention aims at providing systems that depend on sustainable natural forces that do not change by force, direction, or amount. These systems depend on sustainable properties in the nature of fluid and the force that continuously affects the molecules in sustainable proportions, namely atmospheric pressure, gravity, and entropy.

### SUMMARY

This summary is provided to introduce a selection of concepts in a simplified form, which are further described below in the Detailed Description. This summary is not intended to identify key features or essential features of the claimed subject matter. Nor is this summary intended to be used to limit the claimed subject matter's scope.

According to one or more embodiments, a system for producing electrical energy from renewable including fluids, said renewable energy production depends on the natural properties of the said renewable sources, said system including: a power source for providing electric power to said system; an electric pump unit that receives the electric power from said power source and is configured to suck the said fluid present in the system at one side, and discharge the said fluid at another side of the electric pump, wherein said electric pump forms at least a partial vacuum at a suction side of the pump; a tank for containing the said fluid, said tank includes two ends wherein one end is for receiving the discharged fluid and the other end transport the said fluid to an inlet port of the system when said fluid is incompressible fluid; a filter unit provided at both ends of the tank, wherein said filter unit is configured to remove the impurities of said fluid and purifies the fluid before entering into the system; a plurality of turbines including a set of blades that are driven by a force of said fluid when said fluid strikes the blades of the turbine; a plurality of generators connected with said plurality of turbines that generate electrical energy; and a data logger provided in the system and comprising a plurality of sensors that measures one or more characteristics of the said fluid flowing within said system.

According to one or more embodiments, a system for producing electrical energy from renewable sources using a fluid, said renewable energy production depends on the natural properties of the said renewable sources, said system including: a power source for providing electric power to said system; an electric pump unit that receives the electric power from said power source and is configured to suck the said fluid present in the system at one side, and discharge the said fluid at another side of the electric pump, wherein said electric pump forms at least a partial vacuum at a suction side of the pump; a tank for containing the said fluid, said tank includes two ends wherein one end is for receiving the discharged fluid and the other end transports the said fluid to an inlet port of the system when said fluid is incompressible fluid; a plurality of turbines, said plurality of turbines comprises a set of blades that are driven by a force of said fluid when said fluid strikes the blades of the turbine; a plurality of generators connected with said plurality of turbines that generate electrical energy; and a data logger provided in the system and comprising a plurality of sensors that measures one or more characteristics of the said fluid flowing within said system.

According to one or more embodiments, a method of producing an electrical energy from renewable sources using a fluid, said renewable energy production depends on the natural properties of the said renewable sources, said method including the following steps: connecting a power source to an electric pump provided in a power generation system; supplying electric power to an electric pump via said power source and starting the electric pump; making a vacuum at one side of the electric pump when the pump sucks the fluid from one side and discharge it on the other side; transferring the fluid to a tank that contains fluid at a higher level through a pipe, wherein a tank includes a first end and a second send; filtering the fluid via a filtering unit provided at both ends of the tank, said filtering unit is configured to remove the impurities present in said fluid; transporting the said fluid to an inlet port of the system, wherein the fluid flows from the high-pressure regions to low-pressure regions of the system, the said vacuum causes the flow of fluid towards the suction side of the system; driving a plurality of turbines provided in the system by the force of the fluid striking said plurality of turbines; and generating electric power via a plurality of generators that are connected to said plurality of turbine.

According to one or more embodiments, a method of producing an electrical energy from renewable sources using fluid, said renewable energy production depends on the natural properties of the said renewable sources, said method including the following steps: connecting a power source to an electric pump provided in a power generation system; supplying electric power to an electric pump via said power source and starting the electric pump; making a vacuum at one side of the electric pump when the pump sucks the fluid from one side and discharge it on the other side; transferring the fluid to a tank that contains fluid at a higher level through a pipe, wherein a tank includes a first end and a second send when said fluid is incompressible; transporting the said fluid to an inlet port of the system, wherein the fluid flows from the high-pressure regions to low-pressure regions of the system, the said vacuum causes the flow of fluid towards the suction side of the system; driving a plurality of turbines provided in the system by the force of the fluid striking said plurality of turbines; and generating electric power via a plurality of generators that are connected to said plurality of turbine.

According to one or more embodiments, the present disclosure provides an at least partially renewable energy generation apparatus and method. The present disclosure is related to renewable energy generation using multiple and interconnected turbine systems for renewable energy generation that depends on the natural properties of fluids (e.g., fluid flow, the fluid takes the shape of its container, etc.) and natural factors (e.g., gravity, atmospheric pressure, entropy, etc.) by running pumps (e.g., partial vacuum-pump theory) or by using compressors or both to generate a differential pressure within the model or a differential pressure between the inside and the outside of the model. This allows fluids to flow in the pipe that connects that the parts of the model. However, fluid flow is a natural property of fluids in which fluids flow from areas of high pressure to areas of low pressure. When the fluid flows after the pump or compressor (or both) are running, the flow inside the pipe will create enough speed and power to spin the turbine which, in turn, spins the generators to generate electricity. When a group of consecutive turbines are connected to a single channel, the system may produce more power than the input power. A requirement of a pump (or compressors) is to push the fluid into the channel or empty it in order to generate motion capable of turning at least one turbine. Other turbines in the system may produce clean power by relying on natural forces and fluid properties thus creating clean renewable energy. Pumps (or compressors) need an external power source to initially operate the system, and after the system's generator is producing enough energy to sustain the pump, the external power source may be disconnected and the pump or compressor may be powered by the energy generated by the system itself. According to one or more embodiments of the invention, the external power source may be re-connected to the pump.

The present invention teaches multiple embodiments for renewable energy systems that depend on the properties of fluid as it flows inside a pipe and how natural forces affect the molecules of fluid after making a vacuum at the end of the flow path to form a differential pressure. The flow of fluid molecules will spin the turbines that make the generators connected to them able to generate renewable energy. An abbreviation for the disclosed systems may be HAZRE-SYSTEMS. According to one or more embodiments, a system of HAZRE-SYSTEMS is referred to as HAZRE-O, or HAZRE Open System. According to one or more embodiments, the second system is referred to as HAZRE-C, or HAZRE Closed System. According to one or more embodiments, the Open System depends mainly on the force of the atmospheric pressure and its effect on the fluid molecules used to operate the models. According to one or more embodiments, the Closed System does not have a significant effect from the atmospheric pressure. According to one or more embodiments, the Open System has two ends of the pipe connecting the parts of the models that are directly exposed to the forces of atmospheric pressure. According to one or more embodiments, the atmospheric pressure does not affect the fluid inside the Closed System in which the pipe connecting all the parts of the models is connected to itself at both ends. According to one or more embodiments, in an Open System, the fluid inlet port of the open system is completely submerged in a tank (opened from the upper part) containing the same fluid used to operate the system.

According to one or more embodiments, a system may handling incompressible fluids or compressible fluids. According to one or more embodiments, an incompressible fluid system contains an addiction vacuum container to increase the efficiency of the pump.

This summary is provided to introduce a selection of concepts in a simplified form, which are further described below in the Detailed Description. Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description

This summary is not intended to identify key features or essential features of the claimed subject matter. Nor is this summary aimed to be used to limit the claimed subject matter's scope. In this part, there are also some physical concepts that will be indicated; these concepts are, however, necessary to understand the working mechanism of the invention. The understanding of these concepts is indispensable to improve the design of the parts that have been revealed in the systems of this invention or to add other parts which are necessary to increase the coefficient of performance in the systems.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants.

In addition, the drawings may contain other marks owned by third parties and are being used for illustrative purposes only. All rights to various trademarks and copyrights represented herein, except those belonging to their respective owners, are vested in and the property of the applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1A shows a flow chart of an incompressible fluid mode in a HAZRE open system, in accordance with the various embodiments.

FIG. 1B shows a flow chart of the compressible fluid mode in HAZRE open system, in accordance with the various embodiments.

FIG. 1C shows the flow chart of the incompressible fluid model in HAZRE close system, in accordance with the various embodiments.

FIG. 1D shows a flow chart of an incompressible fluid mode in HAZRE open system, in accordance with the various embodiments.

FIG. 2 shows various views of the HAZRE system, in accordance with the various embodiments.

FIG. 3A shows a lateral cross section of an incompressible fluid model in an open system, in accordance with the various embodiments.

FIG. 3B shows a top and side view of a section of an incompressible fluid model in an open system, in accordance with the various embodiments.

FIG. 3C shows a lateral cross section of a turbine blade shape in an open system of an incompressible fluid model, in accordance with the various embodiments.

FIG. 4 shows various views various views of the compressible fluid model of HAZRE-open system, in accordance with various embodiments.

FIG. 5A shows a lateral cross section of an incompressible fluid model in a closed system, in accordance with the various embodiments.

FIG. 5B shows a top and side view of a section of an incompressible fluid model in a closed system, in accordance with the various embodiments.

FIG. 5C shows a lateral cross section of a turbine blade shape in a closed system of an incompressible fluid model, in accordance with the various embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features.

Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure. Accordingly, while embodiments are described herein in detail in relation to one or more embodiments, it is to be understood that this disclosure is illustrative and exemplary of the present disclosure, and are made merely for the purposes of providing a full and enabling disclosure.

The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive.

Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.” The following detailed description refers to the accompanying drawings. Wherever possible, the same reference numbers are used in the drawings and the following description to refer to the same or similar elements. While many embodiments of the disclosure may be described, modifications, adaptations, and other implementations are possible.

For example, substitutions, additions, or modifications may be made to the elements illustrated in the drawings, and the methods described herein may be modified by substituting, reordering, or adding stages to the disclosed methods.

Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of systems including multiple and interconnected turbines for generation renewable energy relying on the natural properties of the fluids and natural forces, by running pumps, compressors, or both, embodiments of the present disclosure are not limited to use only in this context.

### Overview

The present disclosure teaches renewable energy generation. The present disclosure is related to renewable energy generation using multiple and interconnected turbine systems for renewable energy generation that depends on the natural properties of fluids (e.g., the fluid has the ability to flow, the fluid takes the shape of its container, etc.) and natural forces (e.g., gravity, atmospheric pressure, entropy, etc.) by running pumps (e.g., partial vacuum-pump theory) or by using compressors or both to generate a differential pressure within the model or a differential pressure between the inside and the outside of the model. This allows fluids to flow in the tube in a pipe that connects that the parts of the model. Fluid flow is a natural property of fluids in which fluids flow from areas of high pressure to areas of low pressure.

According to one or more embodiments, the system contains a pump connected to a pipe from the suction flange and the discharge flange, and from the suction side of the pump a group of turbines are placed inside rooms connected to the main pipe. From the side of the suction flange, the pump creates a low pressure (e.g., partial vacuum), after the pump generates a partial vacuum, natural factors create fluid flow within the models. The flow may eliminate the partial vacuum created by the pump, but the turbines precede the suction flange of the pump and therefore its rotation is the result of those factors that work to balance the fluid pressure inside the model. The rotation of the turbines as a result of natural factors leads to the generation of renewable energy

According to one or more embodiments, when the fluid flows after the pump or compressor (or both) are running, the flow inside the pipe will create enough speed and power to spin the turbine which, in turn, spins the generators to generate electricity. When a group of consecutive turbines are connected to a single channel, the system may produce more power than the initial power input to the system to start the pump. We will need a pump (or compressors) that can push the fluid into the channel or empty it in order to generate motion capable of turning at least one turbine. Other turbines in the system may produce clean power by relying on natural forces and fluid properties. Such power may be clean renewable energy.

Pumps (or compressors), generally need an external power source to operate the system, and after the system begins to generate enough power to power the pump, the external source may be disconnected, and the pump or compressor may be powered from the energy generated by the system itself.

### Fundamental Concepts

To aid in understanding the present disclosure, some general concepts in physics, fluid mechanics, and the way the pump and heat pump work as they related to the renewable energy systems is discussed. The basic concepts are symbolically indicated with an explanation of how atmospheric pressure and entropy affect in a relatively broader way, and the reference to the heat pump shows that the systems in the current disclosure of renewable energy generation to show adherence with the classical laws of physics (e.g., the first law of thermodynamics).

Continuity equation, Bernoulli equation, weight pressure of fluid and the effect of gravity on flow, kinetic theory of molecules, pump theory, static pressure, fluid properties are important concepts to understand the invention.

### Heat Pump

The heat pump is referred to in the current disclosure to clarify the difference between efficiency and Coefficient of Performance.

Since the efficiency of any device cannot be higher than one, the apparent efficiency of the heat pump (e.g., Coefficient of Performance) reaches six times the input power. Because the heat pump works to transfer energy from one place to another, not to generate that energy. According to one or more embodiments, the work of pump in the systems is limited to transferring fluid (energy) from the suction flange to the discharging flange and does not work on creating the flow within the systems

### Entropy

Every fluid has a degree of disorder, the maximum degree of that disorder being the settling point for changing the shape of that fluid. In other words, the stability of the fluid in its container is the highest degree of entropy “Fluids at Rest”. This means that the fluid is by nature trying to take the shape of the container or fill it, because the fluid molecules contain energy that enables them to move freely.

In other words, the highest degree of entropy of the gas is that it fills the container. The highest degree of entropy for a liquid to take the shape of a container. This means that the fluid is by nature trying to take the shape of the container or fill it, because the fluid molecules contain energy that enables them to swing. Therefore, any action prevents the fluid from moving towards its highest entropy (highest entropy means the highest possible degree of disorder). The fluid will exert effective pressure to remove that cause. And because a partial vacuum is an abnormal disorder in the fluid. Therefore, the molecules that surrounding the partial vacuum will exert pressure on the partial vacuum with the same pressure as the molecules that affect the molecules that surrounding the partial vacuum from the other side. The difference in the number of molecules between the partial vacuum and the next area on the side of the suction flange of the pump will convert to differential pressure. Thus, the differential pressure will make an effective pressure that appears as a flow. And because the partial vacuum in which the number of fluid molecules decreases largely, therefore, the difference in the number's concentration of particles between the partial vacuum and the regions following the vacuum from the suction side of the pump will turn into differential pressure, and thus effective pressure.

When the concentration on energy is increased, the entropy will disorder it, and the production of any areas of high concentration within a closed system containing a fluid, the entropy will increase the disorder among the molecules of the fluid in order to make the pressure equal inside that fluid. This is exactly what is made in renewable energy systems which are explained by the disclosure. In the current disclosure, when creating a low pressure (partial vacuum) in the open system, the atmospheric pressure will be higher entropy, and the number of molecules in the volume unit outside the system is higher compared to the number of fluid molecules according to the same volume unit inside the system. This means that the energy outside the system is higher than the energy inside the system, and therefore, the entropy will work on disseminating the energy until it becomes equal inside and outside the system, and this indicates that energy will be transmitted from the areas of high concentration (outside the system) to the areas of low concentration (inside the system). This transmission of the energy will appear in the form of effective pressure to push a number of fluid molecules inside the system, which is equal to the number of fluid molecules discharge outside the system by the pump (equation of continuity). According to one or more embodiments, in the Closed System, the pump produces areas of a low concentration from the suction side and those of high concentration from the discharging side, thereby the entropy will work on disorder the energy on both sides. This disorder appears in the form of fluid flow inside the pipe of the system and moves from the discharging side to the suction side. The existence of a high-temperature degree in the atmosphere (compared to absolute zero) indicates that there is high energy in the atmosphere. This energy stems from different sources (e.g., solar energy), which are scattered by the entropy. This energy that is found in the atmosphere, however, works as a source feeding the molecules of the matter. According to one or more embodiments, the systems of the present disclosure make the energy that goes towards the entropy responsible for producing the flow inside these systems.

### Atmospheric Pressure

The effect of atmospheric pressure is ignored in most physical calculations due to the reason that most experiments in nature are surrounded by air, as well as the objects submerged in a fluid have equal pressure from all directions at a certain point. Hence, the atmospheric pressure is not effective on all the objects that fall within the earth's atmosphere because the total sum of forces is approximately equal to zero on a particular object. According to one or more embodiments, the Open System, creates a vacuum inside the models, thereby making the impact of atmospheric pressure effective because that vacuum removes molecules of air in the volume in which the partial vacuum is created. This decrease in the number of molecules is, however, contrasted with nature, and therefore, natural forces will work on removing any resistance that can be destroyed in order to restore the system in which the number of molecules is equal in any place and, thus, the resistance that arises from the turbine's interception of the flow of fluid-driven mainly by atmospheric pressure forces is unable to impede the flow, causing it to spin to generate renewable energy.

### HAZRE Open System

According to one or more embodiments, the open system includes: firstly, an external source of energy is needed to run the pump, and when the pump starts working, it will suction some fluid from the inside of the system, as well as discharging the fluid outside of the system. This process will produce differential pressure inside the system, and this differential pressure will be between the suction side of the pump and the other parts of the system. The pressure in the suction side may be equal or approximately equal to zero, while in the other parts, it will be equal to the main pressure before running the pump (the main pressure is equal to atmospheric pressure if the air is used as a fluid for the system. If an incompressible fluid is used as a fluid for the system, for example, water then the main pressure is equal to the atmospheric pressure+the water column pressure between two points, i.e., the highest point in the tank and the lowest point in the suction side of the pump).

### MODLE a (Model of Compressible Fluid in HAZRE Open System)

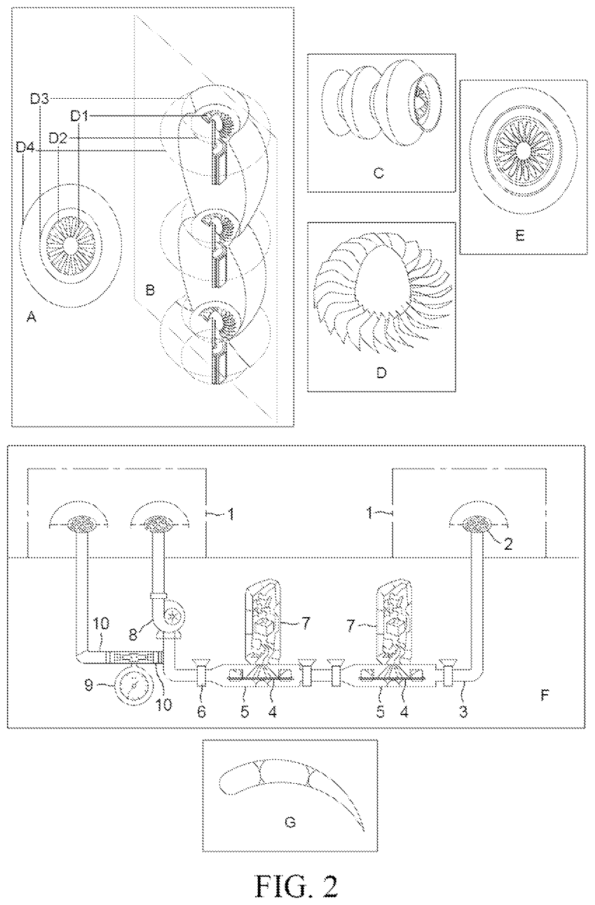

According to one or more embodiments, in the HAZRE open system model, air used as the fluid for the model, and the pump (e.g., centrifugal fans) is used as a device to make the pressure difference as shown in FIG. 2. An external source of energy is needed to run the pump as the system begins to operate, and when the pump starts working, it will suction some fluid from the inside of the system, as well as discharging the fluid outside of the system. This process will produce differential pressure inside the system, and this differential pressure will be between the suction side of the pump and the other parts of the system. The pressure in the suction side will be equal or approximately equal to zero, while in the other parts, it will be equal to the main pressure before running the pump (the main pressure is equal to atmospheric pressure if the air is used as a fluid for the system)

After producing the differential pressure, fluids will move from the high-pressure point to the low-pressure point as shown in FIG. 7. Nevertheless, when the pump works, it will discharge some air from the inside of the system to the outside. This lost quantity of air will produce a differential pressure between the inside of the system and the atmospheric pressure which, in turn, will prompt the atmospheric pressure to push a quantity of air to the inside of the system, which is equal to the lost quantity of air according to continuity equation in order to eradicate the vacuum which the pump creates after running. The reason why the atmospheric pressure pushes a quantity of air that is equal to the quantity of the lost air is the gravity, the distribution of gases and entropy. These natural factors may help to make the system works stably and the pressure inside the system is equal to the outside pressure in case the new quantity of air stabilizes inside the model. But the pump continuously creates a partial vacuum according to pump theory. Moreover, these natural factors will also continue pushing fluid (e.g., air) inside the model whenever there is a vacuum creates a differential pressure. This means that these factors will continue pushing air inside the model as long as the pump is running.

According to one or more embodiments, as illustrated above, the natural factors will continue pushing air inside the system while the pump is running. This indicates that the system changes the atmospheric pressure into effective pressure. This effective pressure will continuously push new air into the system from the inlet side to the suction side of the pump. The flow of the effective pressure will pass through the turbines making them spinning. The spinning of the turbines will make the shafts spinning which, in turn, make the generators spinning, thereby generating renewable energy.

According to one or more embodiments, renewable energy is generated from the generators inside the system dependent on the effective pressure produced by the natural factors and the characteristics of the air. This means that the pump works only to produce differential pressure (partial vacuum). The reason for the spinning of the turbines is due to the effective pressure, and this means that there is no discrepancy with the first law of thermodynamics. However, this means that the system can generate greater energy than the energy used to run the pump because the energy produced by the generator depends on the effective pressure produced by the natural factors.

After the generators work on generating renewable energy, the pump can be separated from the external source of energy and the pump energy is provided from the energy generated by the generators, while the rest of the energy can be used for other purposes, such as lighting, heating, cooling and etc.

### MODLE B (Model of Incompressible Fluid in HAZRE Open System)

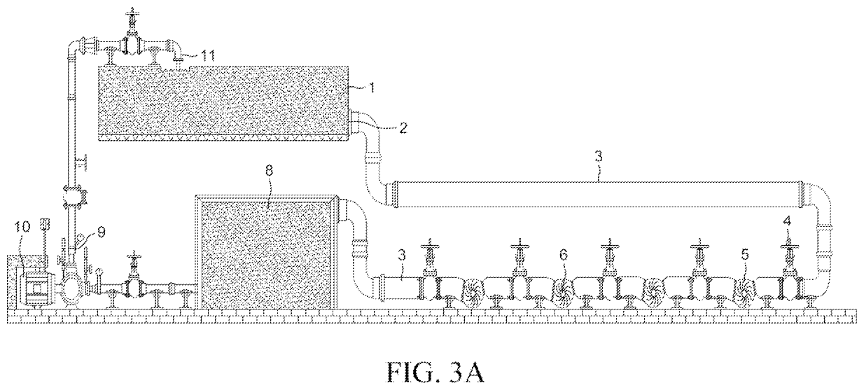

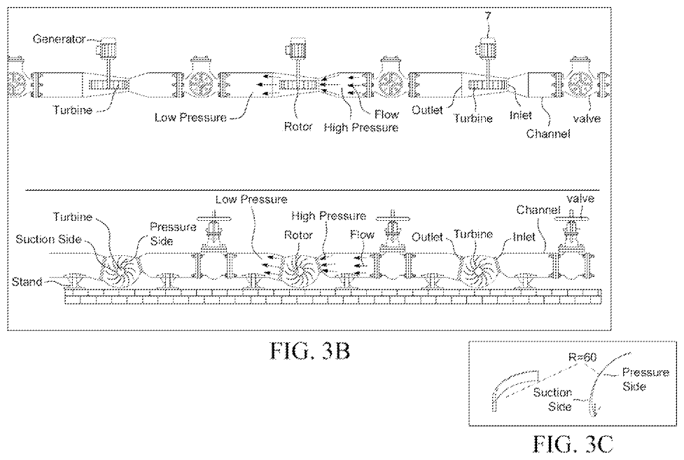

According to one or more embodiments, in the HAZRE open system model, water used as the fluid for the model, and the pump (centrifugal pump) used as a device to make the pressure difference as shown in FIG. 3.

An external source of energy is needed to initially run the pump, and when the pump begins to operate, the pump will suction some fluid from the inside of the system, as well as discharging the fluid in the tank. This process will produce differential pressure inside the system, and this differential pressure will be between the suction side of the pump and the other parts of the system. The pressure in the suction side may be equal or approximately equal to zero, while in the other parts, it will be equal to the main pressure before running the pump (If an incompressible fluid, like water, is used as a fluid in this model, then the main pressure is equal to the atmospheric pressure+the water column pressure between two points, i.e., the highest point in the tank and the lowest point in the suction side of the pump). After producing the differential pressure, fluid (e.g., water) will move from the high-pressure point (tank) to the low-pressure point (suction side). During pump operation, the pump will discharge some water from the inside of the system to the outside (e.g., tank). This lost quantity of water will produce a differential pressure between the inside of the system and the fluid pressure in the tank which, in turn, will prompt the atmospheric pressure to push on the surface of the water in the tank, pushing a quantity of water to the inside of the system, which is equal to the lost quantity of water according to continuity equation in order to eradicate the vacuum which the pump creates after running.

The reason why some water will flow from the tank into the model is gravity. The amount of water that will flow into the model is equal to the same amount of water that the pump discharges to the tank (the continuity equation). Because atmospheric pressure turns into effective pressure pressing on the surface of the water inside the tank. Moreover, the force of gravity works to pull the water molecules down, and because of the ability of fluids to flow and take the shape of the container, the natural factors will work to make the model stable (the pressure will be equal at some level) and the pressure inside the system is equal to the outside pressure in case the new quantity of water stabilizes inside the model. The pump continuously creates a partial vacuum according to pump theory. Additionally, these natural factors will also continue pushing fluid (e.g., water) inside the model whenever there is a vacuum creates a differential pressure. This means that these factors will continue pushing water inside the model as long as the pump is running. That is, the effective pressure that makes the fluid flow into the model is a result of the natural forces and the properties of the fluid, and this pressure is responsible for spinning the turbines inside the model.

According to one or more embodiments, the natural factors will continue pushing water inside the system while the pump is running. This indicates that the system changes atmospheric pressure+the water column pressure into effective pressure. This effective pressure will continuously push new water into the system from the inlet side to the suction side of the pump. The flow of the effective pressure will pass through the turbines making them spinning. The spinning of the turbines will make the shafts spinning which, in turn, makes the generators spinning, thereby generating renewable energy.

According to one or more embodiments, renewable energy is generated from the generators inside the system dependent on the effective pressure produced by the natural factors and the characteristics of the air. This means that the pump works only to produce differential pressure (partial vacuum). The reason for the spinning of the turbines is due to the effective pressure, and this means that there is no discrepancy with the first law of thermodynamics. Accordingly, the system may generate greater energy than the energy used to run the pump because the energy produced by the generator depends on the effective pressure produced by the natural factors.

After the generators produce renewable energy, the pump can be separated from the external source of energy and is provided from the energy generated by the generators, while the rest of the energy can be used for other purposes, such as lighting, heating, cooling and etc.

### HAZRE Close System

According to one or more embodiments, the HAZRE close-system can be summarized as follows: firstly, an external source of energy is needed to run the pump, and when the pump starts working, it will suction some fluid from one side of the model, moving this amount of fluid into the other side of the model. This process will produce two differential pressures inside the model. The first differential pressure will be between the suction side of the pump and the other parts of the model. The pressure in the suction side will be equal or approximately equal to zero, while in the other parts, it will be equal to the main pressure before running the pump. The second differential pressure will be generated when the pump transfers some fluid from the suction side to the discharging side, and this indicates that there is an increase in the molecules of fluid in the discharging side of the pump. This increase in the molecules of fluid means an increase in the pressure in the discharging side compared to the main pressure. These differential pressures will be naturally converted into effective pressure, and this effective pressure will make the molecules of fluid flow inside the model. This effective pressure will be generated due to the natural factors and the properties of fluid that work on disorder energy inside the model.

According to one or more embodiments, differential pressures may be naturally converted into effective pressure, and this effective pressure will make the molecules of fluid flow inside the model. This effective pressure will be generated due to the natural factors and the properties of fluid that work on distributing energy inside the model. This effective pressure will gradually decrease whenever the fluid inside the model reaches the highest possible entropy degrees, and it will completely stop at the highest entropy degree inside the fluid. As long as the pump continues working, the partial vacuum inside the system will be created. This means that this effective pressure will exist as long as the pump is working. Therefore, the fluid will flow from the discharge side to the suction side in the model. During this fluid flow inside the model, it will rotate the turbines inside the model and, thus, generating renewable energy because the rotation of the turbines inside the model is due to the presence of a flow that occurs naturally inside the model. Because this flow arose due to the presence of an unequal number of fluid molecules inside the model. The lack of distribution of the number of fluid molecules within the model and the presence of a greater number in one area and fewer in another region means that the energy is spread unevenly within the model because each of the fluid molecules carries a certain amount of energy, and thus the transfer of fluid molecules from one region to another is because of the entropy that disorder energy evenly within any system MODLE A (Model of compressible fluid in HAZRE close system)

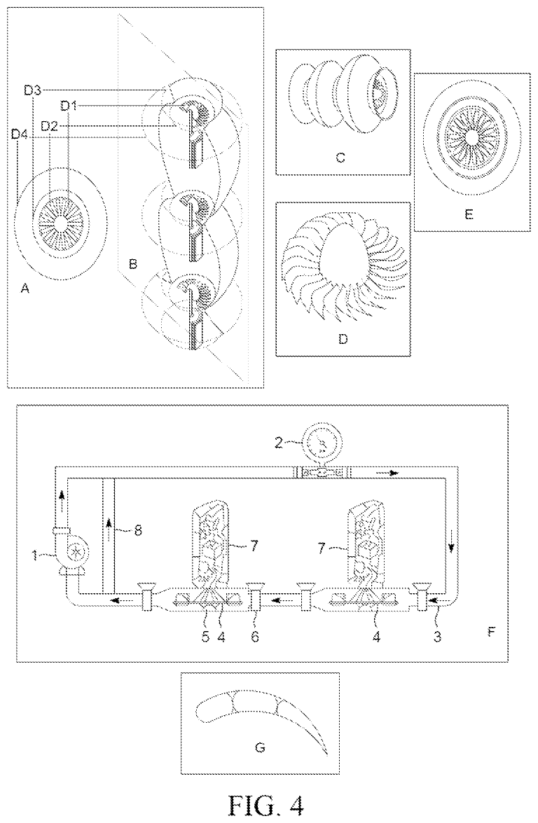

According to one or more embodiments, in a HAZRE closed system model, air used as the fluid for the model, and the pump (centrifugal fans) used as a device to make the pressure difference as shown in FIG. 4. An external source of energy is needed to run the pump, and when the pump operates, it will suction some fluid from the suction side of the pump and discharging this fluid into discharging side of the pump.

This process will produce two differential pressures inside the system; the first one is the differential pressure between the suction side of the pump and the other parts of the model. The pressure in the suction side will be equal or approximately equal to zero, while in the other parts, it will be equal to the main pressure before running the pump (the main pressure in the closed system for compressible fluid model fluid can be adapted freely in accordance with the kind of the pump and the fluid used). The second differential pressure is between the discharging side of the pump and the other parts of the model in which the pressure at the discharging side of the pump is higher than the main pressure of the model. After producing the differential pressure, the fluids will naturally flow from the high-pressure point to the low-pressure point. When the pump starts working, it will transfer the fluid molecules from one end to another, and this will produce a disruption in the nature of fluid inside the model. This indicates that the fluid molecules that are existed in the high-pressure areas are more than those found in the low-pressure areas according to the same unit volume. Because every molecule of fluid carries a certain amount of energy, the high-pressure areas will have higher energy than the low-pressure areas according to the same unit volume. This difference in the energy concentration areas within the nature of the fluid will create an effective pressure which, in turn, will create fluid flow inside the model resulted from a physical principle, which is the entropy that works on disorder the energy inside the system. This disorder of energy will appear in the form of fluid flow due to the natural properties of the fluid.

The Second Law of Thermodynamics Related to Generation of Effective Pressure within HAZRE-Close System

Generally speaking, the entropy disorder energy inside any system. This happens inside the fluids by increasing the random motion of the molecules of fluid. When the fluid molecule acquires energy, it will appear in the form of random motion, thereby it will run into its surrounding fluid molecules, and these surrounding molecules will acquire energy and move randomly. Moreover, when these molecules acquire this random motion, they will also run into the other surrounding molecules. This process, however, will continue until the last molecule of the fluid, resulting in the disorder of energy because of the entropy. This means that all fluid molecules will acquire the same amount of energy and have the same random motion, which is explained by the kinetic theory of molecules. A fluid molecule is stable as long as the temperature is at absolute zero, but it moves randomly when it acquires energy. This random motion of the molecule means that the molecule stores energy in a particular way, and since energy always transfers towards entropy, all the surrounding energy sources will provide this molecule with energy. This means that solar energy and other sources of energy on the earth provide the molecules of fluids with energy, which appears in the form of random motion inside the molecules of the fluids. And this random motion is the reason that makes the fluid takes the shape of a container. According to one or more embodiments, the closed system of compressible fluid model, after running the pump, it will make a partial vacuum inside the fluid. After generating this partial vacuum inside the model, there will be high-pressure areas containing a higher number of fluid molecules compared to the areas of low-pressure according to the same unit volume. This means the fluid after running the pump does not take the shape of the container, which is an unnatural status of the fluid. Hence, the natural factors will create an effective pressure that produces fluid flow towards the partial vacuum, forcing the fluid into taking the shape of the container. The resulted effective pressure inside the model will be a result of the energy that has transferred towards the entropy and the natural properties of fluid as illustrated previously.

The fluid will be distributed naturally inside the container according to the physical principles without any external intervention, rather there will be a need for a lot of energy to stop these factors to prevent entropy from pushing the fluid towards areas of low concentration. Thus, the effective pressure will make the fluid flow higher than the resistance caused by the blades of the turbine during the fluid motion towards the low-pressure areas. These natural factors will not stop creating effective pressure as long as there are different pressure areas that are in opposition to nature inside the model. When the fluid takes the shape of the model, these factors will stop producing effective pressure that creates fluid flow inside the model. The pump continuously creates a partial vacuum according to pump theory. Moreover, these natural factors will also continue pushing fluid (e.g., air) inside the model whenever there is a vacuum creates a differential pressure. This means that these factors will continue pushing air inside the model as long as the pump is running.

According to one or more embodiments, the natural factors will continue pushing air inside the system while the pump is running. As nature continues to create effective pressure that leads to fluid flow for the stability of the system, the turbines will continue to rotate and thus produce electrical energy that depends on the natural factors that led to the formation of effective pressure that moves the fluid from areas of high concentration to areas of low concentration, and therefore what is produced will be renewable energy as the fluid particles exploit the presence of a temperature higher than absolute zero in the atmosphere to increase their random movement according to the kinetic theory of fluid particles.

According to one or more embodiments, renewable energy is generated from the generators inside the system dependent on the effective pressure produced by the natural factors and the characteristics of the air. This means that the pump works only to produce differential pressure (partial vacuum). The reason for the spinning of the turbines is due to the effective pressure, and this means that there is no discrepancy with the first law of thermodynamics. Accordingly, that the system may generate greater energy than the energy used to run the pump because the energy produced by the generator depends on the effective pressure produced by the natural factors.

According to one or more embodiments, after the generators produce renewable energy, the pump can be separated from the external source of energy and is provided from the energy generated by the generators, while the rest of the energy can be used for other purposes, such as lighting, heating, cooling and etc.

### MODLE B (Model of Incompressible Fluid in HAZRE Close System)

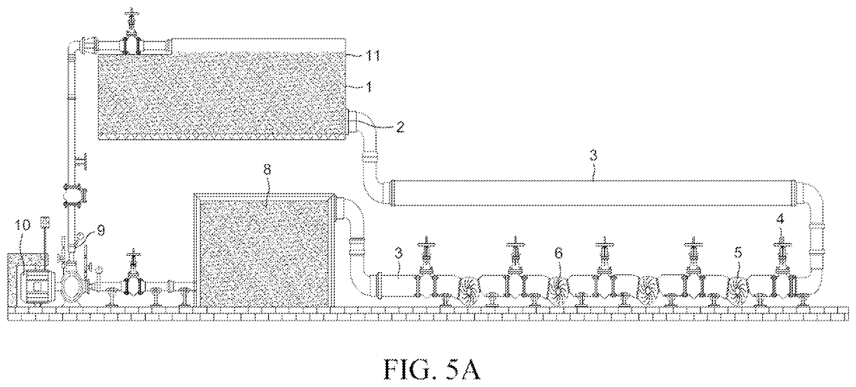

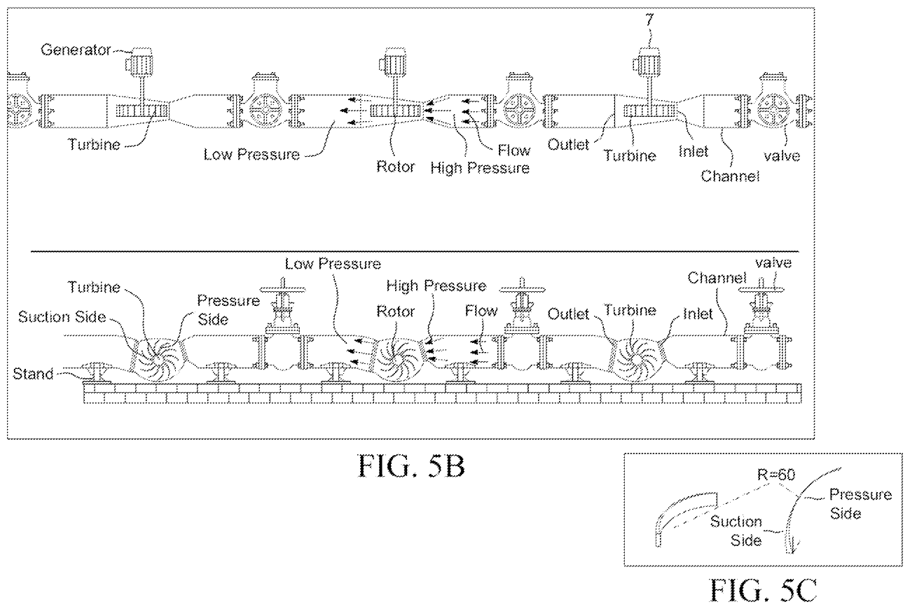

According to one or more embodiments, in the HAZRE closed system, water is used as the fluid for the model, and the pump (centrifugal pump) used as a device to make the pressure difference as shown in FIG. 5.

An external source of energy is needed to run the pump initially, and when the pump operates, it will suction some fluid from the suction side of the pump and discharging this fluid into discharging side of the pump.

This process will produce two differential pressures inside the system; the first one is the differential pressure between the suction side of the pump and the other parts of the model. The pressure in the suction side will be equal or approximately equal to zero, while in the other parts, it will be equal to the main pressure before running the pump (the main pressure in a HAZRE close system for an incompressible fluid model depends on fluid statics. This means that the main pressure will be variable depending on the state of each fluid, its density, temperature, and the height of the main tank comparing the vacuum incubator.). The second differential pressure, on the other hand, is between the discharging side of the pump and the other parts of the model in which the pressure at the discharging side of the pump is higher than the main pressure of the model.

After producing the differential pressure, the fluids will naturally flow from the high-pressure point to the low-pressure point. When the pump starts working, it will transfer the fluid molecules from one end to another, and this will produce a disruption in the nature of fluid inside the model. This indicates that the fluid molecules that are existed in the high-pressure areas are more than those found in the low-pressure areas according to the same unit volume. Because every molecule of fluid carries a certain amount of energy, the high-pressure areas will have higher energy than the low-pressure areas according to the same unit volume. This difference in the energy concentration areas within the nature of the fluid will create an effective pressure which, in turn, will create fluid flow inside the model resulted from a physical principle, which is the entropy that works on equally disorder the energy inside the system. This disorder of energy will appear in the form of fluid flow due to the natural properties of the fluid.

The Second Law of Thermodynamics Related to the Generation of Effective Pressure within HAZRE-Close System

Generally speaking, the entropy disorder energy inside any system. This happens inside the fluids by increasing the random motion of the molecules of fluid. When the fluid molecule acquires energy, it will appear in the form of random motion, thereby it will run into its surrounding fluid molecules, and these surrounding molecules will acquire energy and move randomly. Moreover, when these molecules acquire this random motion, they will also run into the other surrounding molecules. This process, however, will continue until the last molecule of the fluid, resulting in the disorder of energy because of the entropy. This means that all fluid molecules will acquire the same amount of energy and have the same random motion, which is explained by the kinetic theory of molecules. A fluid molecule is stable as long as the temperature is at absolute zero, but it moves randomly when it acquires energy. This random motion of the molecule means that the molecule stores energy in a particular way, and since energy always transfers towards entropy, all the surrounding energy sources will provide this molecule with energy. This means that solar energy and other sources of energy on the earth provide the molecules of fluids with energy, which appears in the form of random motion inside the molecules of the fluids. And this random motion is the reason that makes the fluid takes the shape of a container. According to one or more embodiments, in the closed system of compressible fluid model, after running the pump, it will make a partial vacuum inside the fluid. After generating this partial vacuum inside the model, there will be high-pressure areas containing a higher number of fluid molecules compared to the areas of low-pressure according to the same unit volume. This means the fluid after running the pump does not take the shape of the container, which is an unnatural status of the fluid. Hence, the natural factors will create an effective pressure that produces fluid flow towards the partial vacuum, forcing the fluid into taking the shape of the container. The resulted effective pressure inside the model will be a result of the energy that has transferred towards the entropy and the natural properties of fluid as illustrated previously.

The fluid will be distributed within the container according to physical principles naturally without the need to do work on it, rather it takes great energy to stop these factors to prevent entropy from pushing the fluid towards areas of low concentration, so this effective pressure made will be large enough to overcome the turbines it passes through during the movement of fluid particles from areas of high pressure to areas of low pressure. Thus, the turbines start spinning. These natural factors will not stop creating effective pressure as long as there are different pressure areas within the system that are contrary to nature. When the pressures within the model are equal, these factors stop making the flow. The pump continuously creates a partial vacuum according to pump theory. Moreover, these natural factors will also continue pushing fluid (e.g., water) inside the model whenever a vacuum creates a differential pressure. This means that these factors will continue pushing water inside the model as long as the pump is running.

According to one or more embodiments, the natural factors will continue pushing water inside the system while the pump is running. As nature continues to create effective pressure that leads to fluid flow for the stability of the system, the turbines will continue to rotate and thus produce electrical energy that depends on the natural factors that led to the formation of effective pressure that moves the fluid from areas of high concentration to areas of low concentration, and therefore what is produced will be renewable energy as the fluid particles exploit the presence of a temperature higher than absolute zero in the atmosphere to increase their random movement according to the kinetic theory of fluid particles.

According to one or more embodiments, renewable energy may be generated from the generators inside the system dependent on the effective pressure produced by the natural factors and the characteristics of the air. This means that the pump works only to produce differential pressure (partial vacuum). The reason for the spinning of the turbines is due to the effective pressure, and this means that there is no discrepancy with the first law of thermodynamics. This means that the system may generate greater energy than the energy used to run the pump because the energy produced by the generator depends on the effective pressure produced by the natural factors.

According to one or more embodiments, after the generators produce renewable energy, the pump can be separated from the external source of energy and is provided from the energy generated by the generators, while the rest of the energy can be used for other purposes, such as lighting, heating, cooling and etc.

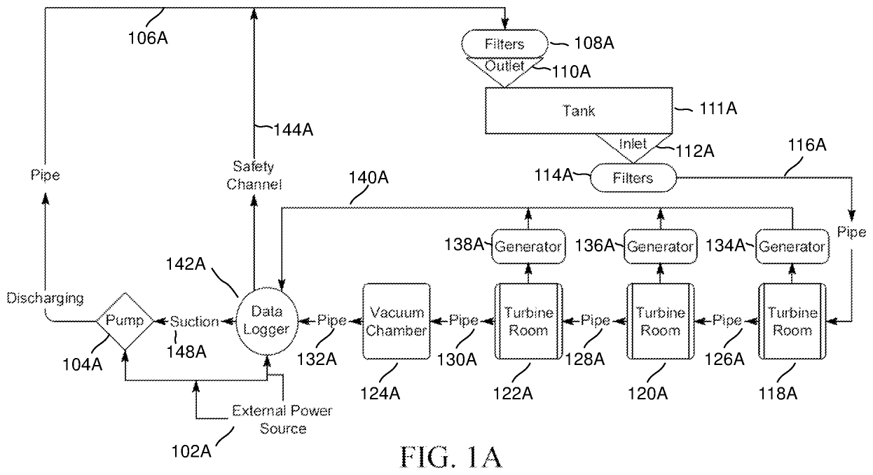

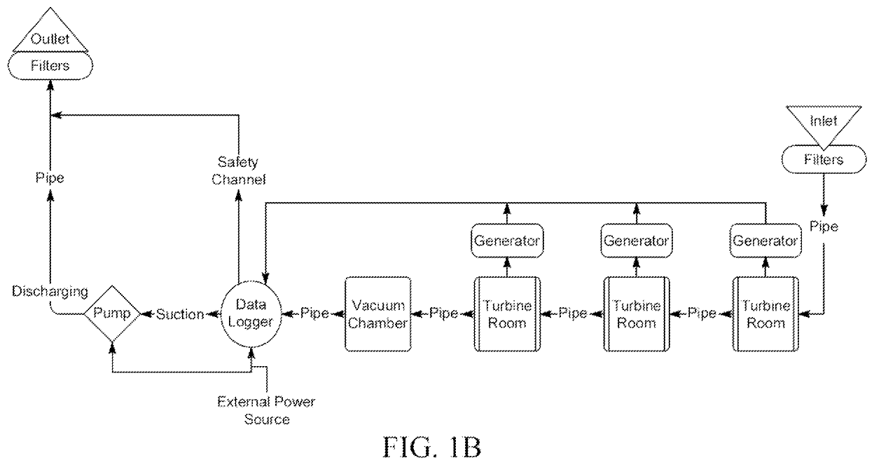

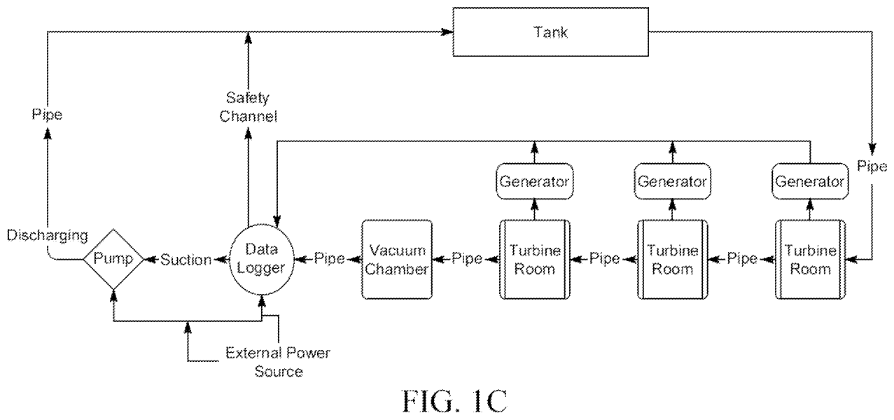

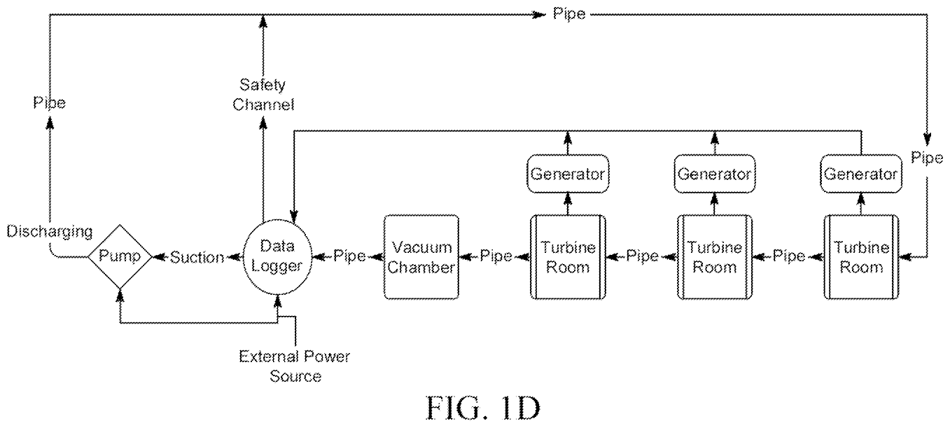

Referring to FIG. 1A, shown is a flow chart of an incompressible fluid mode in a HAZRE open system, in accordance with the various embodiments of the invention. To initialize the system, external power source 102A powers pump 104A. Pump 104A pumps a fluid via pipe 106a to filter 108a. Filter 108A filters the fluid and moves the fluid to tank 111A via outlet 110A. The fluid exits tank 111A via inlet 112A to filter 114A. The fluid is moved to turbine room 118A via pipe 116A. Turbine room 118A spins and rotates the drive shaft of generator 134A which in turn causes electricity on wire 140A. Next, fluid flows to turbine room 120A via pipe 126A. Turbine room 120A rotate the shaft of generator 136A thus creating electricity on wire 140A. Next, the fluid flows to turbine room 122A via pipe 128A. Turbine room 122A rotates the shaft of generator 138A thus creating electricity on wire 140. Next, fluid flows from Turbine Room 122A via pipe 130A to vacuum chamber 124A. Vacuum chamber 124A expands the collision between the particles of fluid and the blades of the turbine. This expansion may reduce the pressure on the area behind the turbine. Next, the fluid is moved to data logger 142A via pipe 132A. Data logger 142A measures various performance characteristics (e.g., voltage, fluid flow, power, etc.). Next, the fluid is moved to pump 104 via suction pipe 148. Safety channel 144A may be used to bypass the pump. Though it is being taught that fluid is moving to different components one at a time, the actual system has continuous flow. After pump 104 ramps up to operating pressure and the generators are producing adequate power to power the pump, the data logger 142A my change the power supply of pump 104A to wire 140A. According to one or more embodiments, data logger 142 may move the power connection for pump 104A to external power source 102A. Though 3 turbine room and generators are being taught, any number and combination of turbine room and generators may be used. According to one or more embodiments, excessive power may be removed from wire 140A for other uses (e.g., lighting, heating, etc.). According to one or more embodiments, each generator may include power management circuitry. According to one or more embodiments, turbine rooms and generators may be enabled and disabled.

Regarding FIG. 1B, shown is a flow chart of the compressible fluid mode in HAZRE open system, in accordance with the various embodiments of the invention. FIG. 1B is similar to FIG. 1A except the tank 111A has been removed to create an open system and additional filters are added.

Regarding FIG. 1C, shown is a flow chart of the incompressible fluid model in HAZRE close system, in accordance with the various embodiments. FIG. 1C is similar FIG. 1A except filters are removed.

Regarding FIG. 1D, shown is a flow chart of an incompressible fluid mode in HAZRE open system, in accordance with the various embodiments. FIG. 1D is similar to FIG. 1A except filters are removed.

Regarding FIG. 2, shown is various views of the HAZRE system, in accordance with the various embodiments. View 2-A is a cross-section of a turbine room, D1 is the diameter of the turbine room, D2 is the entrance to the turbine room, D3 is the diameter of the pipe, and D4 is exit of the turbine room. View 2-B is a section plane for the pipe that shows the arrangement of the turbines and their connection to the generators via the main shaft. View 2-C is an isometric in which the shape of the tube appears at the area of its contact with the turbine rooms. View 2-D is a 3D drawing of a turbine. View 2-E is a 3D drawing view inside the turbine room. View 2-G is a side-section of the turbine blade. View 2-F is a scheme of the compressible fluid model of HAZRE-open system.

According to one or more embodiments, the model of the compressible fluid in the Hazer System contains certain tools to address the compressible fluids as shown in FIG. 2-F. However, these tools can be explained as follows:

(FIG. 2-F-1) refers to The Filter Rooms: this part is put at the beginning and the end of the system. The filter room, however, contains filters to filter the fluid flowing through the system.

(FIG. 2-F-2) refers to the filters: these filters are connected to the beginning and end of a pipe.

(FIG. 2-F-3) refers to the pipe: the ends of the pipe are connected to the filters, and the pipe itself contains the other parts of the model.

(FIG. 2-F-4) refers to a turbine: the turbine is placed inside the turbine room and consists of three parts, which are as follows:

a—the blades:

b—the rotor hub:

c—the shaft: the shaft is connected to the rotor hub, from one side, and is connected to the generator, from the other side.

(FIG. 2-F-5) refers to the turbine room: The turbine room is found inside the pipe, and it contains the turbine. Turbine room is divided into three parts, which are as follows:

a—the inlet of fluid flow: the surface area of the inlet is smaller than the surface area of the pipe to increase the velocity of fluid flow.

b—the chamber: this part is placed between the inlet and the outlet of fluid flow. The chamber begins expanding after the collision point between the particles of fluid and the blades of the turbine. This expansion reduces the pressure on the area behind the turbine. The chamber ends when the expansion reaches the greatest surface area inside the model.

c—the outlet of fluid flow: this part connects the chamber and the pipe. It starts at the greatest surface area and its surface area gradually starts decreasing until it equates to the surface area of the pipe.

f-6 refers to the valves: the valves are located inside the pipe before and after every turbine room.

f-7 refers to the generators and gearbox.

f-8 refers to the pump: the pump is located after the last valve. The suction side of the pump aspirates the fluid and discharges it out of the system.

f-9 refers to data logger: the data logger device contains several sensors intended to measure pressure, the velocity of fluid flow, temperature and so forth.

f-10 refers to safety channel,

View 2-F is a schematic of the compressible fluid model of HAZRE open system for facilitating renewable energy power generation, in accordance with some embodiments. The open system includes multiple and interconnected turbines for generating renewable energy relying on the natural properties of the fluids and natural forces, by running pumps, compressors, or both according to some embodiments. To clarify this scheme, it must be noted each reference number (mentioned below) indicating one of the parts of the renewable electric power plant shown in FIG. 2-F.

The filters rooms 1 may be the first protection rooms that work to purify the fluids (e.g., air) entering and leaving the system (e.g., protecting against insects, dust, etc.) and provides a safe environment for humans. Filters 2 may form a second protection line in the system that works to purify the fluids (e.g., air) entering and leaving the system (e.g., protecting against insects, dust, etc.) and provides a safe environment for humans. Further, pipe 3 works to connect the parts of the system together, and to ensure that the fluids (e.g., air) enter in one path and goes in one direction. Pipe 3 links the entry filters and the exit filters for the fluid and prevents any fluids (e.g., air) from leaking inside the system from any port other than the entry and exit port. A pump suction flange connects the pump to pipe 3 from the side of the fluid inlet into the system. A pump discharge flange connects the pump to the side of the fluid outlet from the system. Pipe 3 is connected to a filter. The filter purifies the fluid (e.g., air) that enters pipe 3. The function of pipe 3 is to connect the turbine rooms to each other within the system, which allows the fluid to move from one turbine room to another. Another function of pipe 3 is to prevent the fluid from leaking into or out of the system and to allow the fluids to enter and exit only from the ports designated for the fluids flow.

Turbine room 5 begins with a relatively narrow opening compared to the diameter of pipe 3, and then the turbine room begins to expand after the turbine is placed, which allows for increasing the flow speed according to Bernoulli's equation. Turbine 4 includes turbine blades that are designed so that the concave side faces the fluid flow direction to increase the speed of the turbine rotation. A rotor turbine is connected to the shaft that connected the turbine to the generator. Turbines 4 transfer the kinetic energy of the fluid molecules that collisions the turbine blades during the flow and convert it into electrical energy by rotating the generator. The turbine blades are designed in such a way that the elastic collision between them and the fluid particles ends up allowing the fluid particles to continue their way without creating a counter flow to the main flow.

Valves 6 are located inside the pipe before and after every turbine room. The function of the valves is to isolate the turbine or turbine room in which a problem occurred from the rest of the model.

Further, the generator and gearbox 7 include connecting through the central main shaft of the turbine to the gearbox, wherein the gearbox is connected through the secondary shaft to the generator, wherein the main shaft connects to the brakes to determine the speed of rotation. There are cooling fans behind the generator.

The pump (centrifugal fans) 8 works to perform suction on the fluid inside the system (in the pipe and turbine rooms) and discharge it out of the system. The rate of fluid flow and the area of the cross-section of the channel of the system that the fluid passes through determines the speed of the fluid inside the system according to the continuity equation.

Data logger 9: The data logger devices contain several sensors intended to measure pressure, the velocity of fluid flow, temperature, and so forth. According to one or more embodiments, safety channel 10 acts as a backup solution to ensure the continuous operation of the electrical station, such as a pump failure or a blockage in the fluid outlet of the model. In these cases, the safety channel can be used.

Regarding FIG. 3, shown is various views of the incompressible fluid model of HAZRE-open system, in accordance with the various embodiments.

View 3-A refers to scheme of the incompressible fluid model of HAZRE-open system. Explanatory diagram of basic parts of the model:

The model of the incompressible fluid in the Hazer System contains certain tools to tackle the incompressible fluids as shown in FIG. 3-A. These tools can be explained as follows:

(FIG. 3-A-1) refers to a tank, the tank contains an incompressible fluid (e.g., water). The fluid in the tank will also fill the model.

(FIG. 3-A-2) refers to The Filters: these filters are connected to the beginning and end of a pipe and the inlet filter connected to the tank form one side and connected to the pipe from another side.

(FIG. 3-A-3) refers to the pipe: the ends of the pipe are connected to the filters, and the pipe itself connected the other parts of the model.

(FIG. 3-A-4) refers to the valves: the valves are located inside the pipe before and after every turbine room.

(FIG. 3-A-5) refers to the turbine room: the turbine room is found inside the pipe, and it contains the turbine. The turbine room is divided into three parts, which are as follows:

a—the inlet of fluid flow: the surface area of the inlet is smaller than the surface area of the pipe to increase the velocity of fluid flow.

b—the chamber: this part is placed between the inlet and the outlet of fluid flow. The chamber begins expanding after the collision point between the particles of fluid and the blades of the turbine. This expansion reduces the pressure on the area behind the turbine. The chamber ends when the expansion reaches the greatest surface area inside the model.

c—the outlet of fluid flow: this part connects the chamber and the pipe. It starts at the greatest surface area and its surface area gradually starts decreasing until it equates to the surface area of the pipe.

(FIG. 3-A-6) refers to turbine: The turbine is placed inside the turbine room and consists of three parts, which are as follows:

a—the blades:

b—the rotor hub:

c—the shaft: the shaft is connected to the rotor hub, from one side, and is connected to the generator, from the other side.

(FIG. 3-A-7) refers to the generators and gearbox:

(FIG. 3-A-8) refers to vacuum container: it is a closed tank that has two ports the pipe can be contacted to the vacuum container through them. The first port is the port far from the pump, which is relatively higher than the port from another one. As for the port near the pump, the pipe level is equal to the level of the pump's suction flange.

(FIG. 3-A-9) refers to data logger: The data logger device contains several sensors intended to measure pressure, the velocity of fluid flow, temperature and so forth.

(FIG. 3-A-10) refers to the pump: the pump is located after vacuum container. The suction side of the pump aspirates the fluid and discharges it out of the system.

(FIG. 3-A-11) refers to fluid outlet: connects to the fluid outlet filter from the model and discharges the fluid into the tank

(FIG. 3-A-12) refers to a safety channel.

(FIG. 3-B) refers to illustrative diagram, top and side view, showing the position of the turbines, main shaft, and generators. Drawings show the shape of the turbine chambers, the position of the valves, and the flow.

(FIG. 3-C) refers to side view of the turbine blade.

FIG. 3-A is a schematic of the incompressible fluid model of HAZRE open system for facilitating renewable energy power generation, in accordance with some embodiments. The open system includes multiple and interconnected turbines for generating renewable energy relying on the natural properties of the fluids and natural forces, by running pumps, compressors, or both according to some embodiments. To clarify this scheme, it is noted each reference number (mentioned below) indicating one of the parts of the renewable electric power plant shown in FIG. 3-A.

Tank 1 contains fluid and its height is higher than the rest of the model parts. When the height of the tank is higher than the rest of the parts of the model, the weight of the fluid inside the tank contributes to adding additional pressure with atmospheric pressure in order to create a stronger flow inside the model. The cap of the upper tank is slightly raised from the side to allow air to enter freely and pressurize the surface of the fluid. Although the air escapes freely from the top cover of the tank, must be designed as the first protection system for the model. Filters 2 may form a second protection line in the model that works to purify the fluids (e.g., water) that flow from the tank to the model (protecting against insects, dust, etc.). Pipe 3 works to connect the parts of the model together, and to ensure that the fluids (such as water) enter in one path and goes in one direction. Pipe 3 links the entry filters and the exit filters for the fluid and prevents any fluids (e.g., water) from leaking inside the model from any port other than the entry and exit port. A pump suction flange connects the pump to pipe 3 from the side of the fluid inlet into the model. Further, a pump discharge flange connects the pump to the side of the fluid outlet from the model. The fluid that returns to the tank. The function of pipe 3 is to connect the turbine rooms to each other within the system, which allows the fluid to move from one turbine room to another. Another function of pipe 3 is to prevent the fluid from leaking into or out of the system and to allow the fluids to enter and exit only from the ports designated for the fluids flow.

Valve 4 is located inside the pipe before and after every turbine room. The function of the valves is to isolate the turbine or turbine room in which a problem occurred from the rest of the model.

Turbine room 5 begins with a relatively narrow opening compared to the diameter of pipe 3, and then the turbine room begins to expand after the turbine is placed, which allows for increasing the flow speed according to Bernoulli's equation. Turbine 6 includes turbine blades that are designed so that the concave side faces the Fluid flow direction to increase the speed of the turbine rotation. A rotor turbine is connected to the shaft that connected the turbine to the generator. Turbines 6 transfer the kinetic energy of the fluid molecules that collisions the turbine blades during the flow and convert it into electrical energy by rotating the generator. The turbine blades are designed in such a way that the elastic collision between them and the fluid particles ends up allowing the fluid particles to continue their way without creating a counter flow to the main flow.

The generator and gearbox 7 include connecting through the central main shaft of the turbine to the gearbox, wherein the gearbox is connected through the secondary shaft to the generator, wherein the main shaft connects to the brakes to determine the speed of rotation. There are cooling fans behind the generator. Vacuum container 8 is located after the last valve, The main function of the vacuum container is to provide additional fluid beside the suction flange of the pump. When the pump is working, the partial vacuum is transmitted directly from the suction flange to the vacuum container. This process makes it easier for the pump to transfer fluids more efficiently and with less energy from inside the model to the tank. Data logger 9: the data logger devices contain several sensors intended to measure pressure, the velocity of fluid flow, temperature, and so forth. The pump (centrifugal pump)10 works to perform suction on the fluid inside the model (in the pipe and turbine rooms) and discharge it out of the model to the tank. The rate of fluid flow and the area of the cross-section of the channel of the system that the fluid passes through determines the speed of the fluid inside the system according to the continuity equation.

Referring to FIG. 4, shown is various views various views of the compressible fluid model of HAZRE-open system, in accordance with the various.

(FIG. 4-F) refers to scheme of the compressible fluid model of HAZRE-open system. Explanatory diagram of basic parts of the model:

The model of the compressible fluid in the Hazer System contains certain tools to tackle the compressible fluids as shown in FIG. 4-F. These tools can be explained as follows:

(FIG. 4-F-1) refers to the pump: In a closed system, the pump moves some of the fluid frequently while it is working from the suction side to the discharge side to generate differential pressures inside the model.

(FIG. 4-F-2) refers to data logger: the data logger device contains several sensors intended to measure pressure, the velocity of fluid flow, temperature and so forth.

(FIG. 4-F-3) refers to the pipe: the ends of the pipe are connected to the suction flange and the discharge flange of the pump, and the pipe itself contains the other parts of the model.

(FIG. 4-F-4) refers to turbine: The turbine is placed inside the turbine room and consists of three parts, which are as follows:

a—the blades:

b—the rotor hub:

c—the shaft: The shaft is connected to the rotor hub, from one side, and is connected to the generator, from the other side.

(FIG. 4-F-5) refers to the turbine room: the turbine room is found inside the pipe, and it contains the turbine. Moreover, the turbine room is divided into three parts, which are as follows:

a—the inlet of fluid flow: the surface area of the inlet is smaller than the surface area of the pipe to increase the velocity of fluid flow.

b—the chamber: this part is placed between the inlet and the outlet of fluid flow. The chamber begins expanding after the collision point between the particles of fluid and the blades of the turbine. This expansion reduces the pressure on the area behind the turbine. The chamber ends when the expansion reaches the greatest surface area inside the model.

c—the outlet of fluid flow: this part connects the chamber and the pipe. It starts at the greatest surface area and its surface area gradually starts decreasing until it equates to the surface area of the pipe.

(FIG. 4-F-6) refers to the valves: the valves are located inside the pipe before and after every turbine room.

(FIG. 4-F-7) refers to the generators and gearbox.

(FIG. 4-F-8) refers to safety channel.

FIG. 4-F is a schematic of the compressible fluid model of HAZRE close system for facilitating renewable energy power generation, in accordance with some embodiments. The close system includes multiple and interconnected turbines for generating renewable energy relying on the natural properties of the fluids and natural forces, by running pumps, compressors, or both according to some embodiments. To clarify this scheme, it must be noted each reference number (mentioned below) indicating one of the parts of the renewable electric power plant shown in FIG. 4-F.

In a closed system, pump 1 moves some of the fluid frequently while it is working from the suction side to the discharge side to generate differential pressures inside the model. The suction flange and the discharge flange of the pump are connected to the pipe. Data logger 2: the data logger devices contain several sensors intended to measure pressure, the velocity of fluid flow, temperature, and so forth. Pipe 3 works to connect the parts of the system together. Pipe 3 links the suction flange and the discharge flange of the pump and prevents any fluids (e.g., air) from leaking inside the system from any port. The function of pipe 3 is to connect the turbine rooms to each other within the system, which allows the fluid to move from one turbine room to another. Another function of pipe 3 is to prevent the fluid from leaking into or out of the system and to allow the fluids to enter and exit only from the ports designated for the fluids flow.

Turbine room 5 begins with a relatively narrow opening compared to the diameter of pipe 3, and then the turbine room begins to expand after the turbine is placed, which allows for increasing the flow speed according to Bernoulli's equation. Turbine 4 includes turbine blades that are designed so that the concave side faces the fluid flow direction to increase the speed of the turbine rotation. A rotor turbine is connected to the shaft that connected the turbine to the generator. Turbines 4 transfer the kinetic energy of the fluid molecules that collisions the turbine blades during the flow and convert it into electrical energy by rotating the generator. The turbine blades are designed in such a way that the elastic collision between them and the fluid particles ends up allowing the fluid particles to continue their way without creating a counter flow to the main flow.

Valves 6 are located inside the pipe before and after every turbine room. the function of the valves is to isolate the turbine or turbine room in which a problem occurred from the rest of the model

The generator and gearbox 7 are connected through the central main shaft of the turbine to the gearbox, wherein the gearbox is connected through the secondary shaft to the generator, wherein the main shaft connects to the brakes to determine the speed of rotation. There are cooling fans behind the generator.

Safety channel 8 is the safety channel acts as a backup solution to ensure the continuous operation of the electrical station, such as a pump failure or a blockage in the fluid outlet of the model. In these cases, the safety channel can be used.

Referring to FIG. 5, shown is various views of incompressible fluid model of HAZRE-open system, in accordance with the various embodiments.

(FIG. 5-A) refers to scheme of the incompressible fluid model of HAZRE-open system. Explanatory diagram of basic parts of the model:

The model of the incompressible fluid in the Hazer System contains certain tools to tackle the incompressible fluids as shown in FIG. 5-A. However, these tools can be explained as follows:

(FIG. 5-A-1) refers to tank, the tank contains an incompressible fluid (e.g., water). The fluid in the tank will also fill the model.

(FIG. 5-A-2) refers to flow port

(FIG. 5-A-3) refers to the pipe: the ends of the pipe are connected the flow and discharging ports, and the pipe itself connected the other parts of the model.

(FIG. 5-A-4) refers to the valves: the valves are located inside the pipe before and after every turbine room.

(FIG. 5-A-5) refers to the turbine room: The turbine room is found inside the pipe, and it contains the turbine. The turbine room is divided into three parts, which are as follows:

a—the inlet of fluid flow: the surface area of the inlet is smaller than the surface area of the pipe to increase the velocity of fluid flow.

b—the chamber: this part is placed between the inlet and the outlet of fluid flow. The chamber begins expanding after the collision point between the particles of fluid and the blades of the turbine. This expansion reduces the pressure on the area behind the turbine. However, the chamber ends when the expansion reaches the greatest surface area inside the model.

c—the outlet of fluid flow: this part connects the chamber and the pipe. It starts at the greatest surface area and its surface area gradually starts decreasing until it equates to the surface area of the pipe.

(FIG. 5-A-6) refers to turbine: the turbine is placed inside the turbine room and consists of three parts, which are as follows:

a—the blades:

b—the rotor hub:

c—the shaft: the shaft is connected to the rotor hub, from one side, and is connected to the generator, from the other side.

(FIG. 5-A-7) refers to the generators and gearbox:

(FIG. 5-A-8) refers to vacuum container: It is a closed tank that has two ports the pipe can be contacted to the vacuum container through them. The first port is the port far from the pump, which is relatively higher than the port from another one. As for the port near the pump, the pipe level is equal to the level of the pump's suction flange.

(FIG. 3-A-9) refers to data logger: the data logger device contains several sensors intended to measure pressure, the velocity of fluid flow, temperature and so forth.

(FIG. 3-A-10) the pump: the pump is located after vacuum container. The suction side of the pump aspirates the fluid and discharges into the tank.

(FIG. 3-A-11) refers to discharging port.

(FIG. 3-A-12) refers to safety channel.

FIG. 5-A is a schematic of the incompressible fluid model of HAZRE close system for facilitating renewable energy power generation, in accordance with some embodiments. The open system includes multiple and interconnected turbines for generating renewable energy relying on the natural properties of the fluids and natural forces, by running pumps, compressors, or both according to some embodiments. To clarify this scheme, it is noted each reference number (mentioned below) indicating one of the parts of the renewable electric power plant shown in FIG. 5-A.

Tank 1 contains fluid and its height is higher than the rest of the model parts. When the height of the tank is higher than the rest of the parts of the model, the weight of the fluid inside the tank contributes to adding additional pressure with the differential pressures in order to create a stronger flow inside the model. Tank 1 is isolated from the external environment and does not contain ports other than the flow port and the discharge port. For flow port 2 the fluid flow port inside the model connects the pipe and tank. Pipe 3 works to connect the parts of the model together, and to ensure that the fluids (e.g., water) enters in one path and goes in one direction. Pipe 3 links flow port 2 and discharging port for the fluid and prevents any fluids (e.g., water) from leaking inside the model from any port other than the flow and discharging port. A pump suction flange connects the pump to pipe 3 from the side of the fluid of the tank inlet into the model. A pump discharge flange connects the pump to the side of the fluid discharging port into the tank. The function of Pipe 3 is to connect the turbine rooms to each other within the system, which allows the fluid to move from one turbine room to another. Another function of pipe 3 is to prevent the fluid from leaking into or out of the system

Further, valve 4 is located inside the pipe before and after every turbine room. the function of the valves is to isolate the turbine or turbine room in which a problem occurred from the rest of the model.

Turbine room 5 begins with a relatively narrow opening compared to the diameter of pipe 3, and then the turbine room begins to expand after the turbine is placed, which allows for increasing the flow speed according to Bernoulli's equation. Turbine 6 includes turbine blades that are designed so that the concave side faces the fluid flow direction to increase the speed of the turbine rotation. A rotor turbine is connected to the shaft that connected the turbine to the generator. Turbines 6 transfer the kinetic energy of the fluid molecules that collisions the turbine blades during the flow and convert it into electrical energy by rotating the generator. The turbine blades are designed in such a way that the elastic collision between them and the fluid particles ends up allowing the fluid particles to continue their way without creating a counter flow to the main flow.

The generator and gearbox 7 include connecting through the central main shaft of the turbine to the gearbox, wherein the gearbox is connected through the secondary shaft to the generator, wherein the main shaft connects to the brakes to determine the speed of rotation. There are cooling fans behind the generator. Vacuum container 8 is located after the last valve. The main function of the vacuum container is to provide additional fluid beside the suction flange of the pump. When the pump is working, the partial vacuum is transmitted directly from the suction flange to the vacuum container. This process makes it easier for the pump to transfer fluids more efficiently and with less energy from inside the model to the tank. Data logger 9: the data logger devices contain several sensors intended to measure pressure, the velocity of fluid flow, temperature, and so forth. The Pump (Centrifugal pump)10 works to perform suction on the fluid inside the model (in the pipe and turbine rooms) and discharge into the tank. The rate of fluid flow and the area of the cross-section of the channel of the system that the fluid passes through determines the speed of the fluid inside the system according to the continuity equation. Discharge port 11 connects the pipe with the tank and is located at the end of the flow cycle after the discharge flange of the pump

What is claimed is:

1. A system for producing electrical energy from renewable sources using a fluid, said renewable energy production depends on the natural properties of the said renewable sources, said system comprising:
a power source for providing electric power to said system;
an electric pump unit that receives the electric power from said power source and is configured to suck the said fluid present in the system at one side, and discharge the said fluid at another side of the electric pump, wherein said electric pump forms at least a partial vacuum at a suction side of the pump;
a tank for containing the said fluid, said tank
includes two ends wherein one end is for receiving the discharged fluid and the other end transport the said fluid to an inlet port of the system when said fluid is incompressible fluid;
a filter unit provided at both ends of the tank, wherein said filter unit is configured to remove the impurities of said fluid and purifies the fluid before entering into the system;
a plurality of turbines including a set of blades that are driven by a force of said fluid when said fluid strikes the blades of the turbine;
a plurality of generators connected with said plurality of turbines that generate electrical energy; and
a data logger provided in the system and comprising a plurality of sensors that measures one or more characteristics of the said fluid flowing within said system.

2. The system as claimed in claim 1, wherein the fluid flows from high-pressure region to low pressure region due to the presence of vacuum inside the system.

3. The system as claimed in claim 1, wherein when said fluid is compressible fluid, the flow of said fluid is driven at least partially by a force of atmospheric pressure.

4. The system as claimed in claim 1, wherein when said fluid is incompressible fluid, the flow of said fluid is driven at least partially by the combination of atmospheric pressure and water column pressure present inside the tank.

5. The system as claimed in claim 1, wherein said plurality of turbine includes one of a Pelton turbine, a cross-flow turbine, a Francis turbine, a Kaplan turbine, a turbo turbine, and a fixed-pitch propeller.

6. The system as claimed in claim 1, wherein said one or more characteristics of the fluid include at least one of a temperature of the fluid, flow rate of the fluid, velocity of the fluid, and the pressure of the fluid within the system.

7. The system as claimed in claim 1, wherein the electric pump is selected from a group consisting of a centrifugal pump, vertical pump, horizontal centrifugal pump, submersible pump, diaphragm pump, gear pump, and peristaltic pump; and said electric pump is configured to form a vacuum at the suction side of the electric pump.

8. The system as claimed in claim 1, wherein a differential pressure exists between the suction side of the electric pump and rest of the part of the system when a vacuum is formed.

9. The system as claimed in claim 1, wherein when said fluid is a compressible fluid, said fluid has variable density.

10. The system as claimed in claim 1, wherein when said fluid is a incompressible fluid, said fluid has constant density.

11. The system as claimed in claim 1 further comprising a safety channel that bypasses said electronic pump to aid in continuous operation of the system.

12. A system for producing electrical energy from renewable sources using a fluid, said renewable energy production depends on the natural properties of the said renewable sources, said system comprising:
a power source for providing electric power to said system;
an electric pump unit that receives the electric power from said power source and is configured to suck the said fluid present in the system at one side, and discharge the said fluid at another side of the electric pump, wherein said electric pump forms at least a partial vacuum at a suction side of the pump;
a tank for containing the said fluid, said tank includes two ends wherein one end is for receiving the discharged fluid and the other end transports the said fluid to an inlet port of the system when said fluid is incompressible fluid;
a plurality of turbines, said plurality of turbines comprises a set of blades that are driven by a force of said fluid when said fluid strikes the blades of the turbine;
a plurality of generators connected with said plurality of turbines that generate electrical energy; and
a data logger provided in the system and comprising a plurality of sensors that measures one or more characteristics of the said fluid flowing within said system.

13. The system as claimed in claim 14, wherein said fluid is isolated within the system and not exposed to the outer environment.

14. The system as claimed in claim 14, wherein the properties and form of the fluid remain constant during operation of said system.

15. The system as claimed in claim 14, wherein a first differential pressure exists between the suction side of the electric pump and rest of the part of the system when a vacuum is formed.

16. The system as claimed in claim 14, wherein a second differential pressure exists between the discharging side of the electric pump and rest of the part of the system when the electric pump transfers the sucked fluid to the other side of the system.

17. A method of producing an electrical energy from renewable sources using a fluid, said renewable energy production depends on the natural properties of the said renewable sources, said method comprising the following steps:
connecting a power source to an electric pump provided in a power generation system;
supplying electric power to an electric pump via said power source and starting the electric pump;
making a vacuum at one side of the electric pump when the pump sucks the fluid from one side and discharge it on the other side;
transferring the fluid to a tank that contains fluid at a higher level through a pipe, wherein a tank includes a first end and a second send;
filtering the fluid via a filtering unit provided at both ends of the tank, said filtering unit is configured to remove the impurities present in said fluid;
transporting the said fluid to an inlet port of the system, wherein the fluid flows from the high-pressure regions to low-pressure regions of the system, the said vacuum causes the flow of fluid towards the suction side of the system;
driving a plurality of turbines provided in the system by the force of the fluid striking said plurality of turbines; and
generating electric power via a plurality of generators that are connected to said plurality of turbine.

18. The method as claimed in claim 17, wherein when said fluid is compressible fluid, the flow of said fluid is driven at least partially by a force of atmospheric pressure.

19. The method as claimed in claim 17, wherein when said fluid is incompressible fluid, the flow of said fluid is driven at least partially by the combination of atmospheric pressure and water column pressure present inside the tank.
